(19) United States
(12) Patent Application Publication
(10) Pub. No.: US 2008/0084705 A1
(43) Pub. Date: Apr. 10, 2008

(54) VEHICLE LAMP ASSEMBLY WITH A ONE-PIECE BEZEL-LENS STRUCTURE

(75) Inventors: Stephen Helwig, Farmington Hills, MI (US); Rich Kirkdorffer, Saline, MI (US); John Kallio, Redford, MI (US); Karl Burkhalter, Norwalk, OH (US); Joe Scranton, Norwalk, OH (US); Stephen McCarthy, Farmington Hills, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/539,696

(22) Filed: Oct. 9, 2006

(51) Int. Cl. B60Q 1/04

(52) U.S. Cl. 362/507; 362/520

(57) ABSTRACT

A lamp assembly includes an external lens, a one-piece bezel-lens structure, and one or more light sources. The one-piece bezel-lens structure is adjacent to the external lens and is formed from a light-transmissive material. The one-piece bezel-lens structure has one or more internal lens portions and one or more opaque portions. The opaque portions are coated with an opaque material. The light source emits light through the internal lens portion of the one-piece bezel-lens structure and the external lens.

### TECHNICAL FIELD

The present invention relates generally to vehicle lamp assemblies, and more particularly to a one-piece bezel-lens structure for a vehicle lamp assembly that decreases the manufacturing cycle time, minimizes costs associated therewith, and enhances vehicle design.

### BACKGROUND

Automotive manufacturers continue to develop lamp assemblies to improve the aesthetic appearance of vehicles and reduce the manufacturing costs of those lamp assemblies. A typical lamp assembly includes a somewhat large number of parts. Common examples of these parts include an external lens, an external housing, and one or more bezels, inner lenses, reflectors, and light sources.

The external lens typically is attached to the external housing so as to define a cavity, which encloses the bezel, inner lens, reflector, and light source. The bezel typically is attached to the external housing and includes an aperture that receives an inner lens, reflector, and light source.

It would therefore be desirable to provide a lamp assembly with fewer parts for minimizing the manufacturing cycle time and decreasing the costs associated therewith.

### SUMMARY OF THE INVENTION

A lamp assembly for a vehicle is provided. The lamp assembly includes an external lens, a one-piece bezel-lens structure, and one or more light sources. The one-piece bezel-lens structure is adjacent to the external lens and is formed from a light-transmissive material. The one-piece bezel-lens structure has one or more internal lens portions and one or more opaque portions. The opaque portions are coated with an opaque material. The light source emits light through the internal lens portion of the one-piece bezel-lens structure and the external lens.

One advantage of the invention is that a lamp assembly is provided that eliminates the need for a separate internal lens and a bezel.

Another advantage of the invention is that a lamp assembly is provided that decreases manufacturing cycle time and costs.

Yet another advantage of the invention is that a lamp assembly is provided that enhances vehicle design and strengthens brand recognition of vehicles by positioning the internal lens in a variety of locations as styling dictates.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a perspective view of a vehicle having a front-end structure with headlamp assemblies, according to one embodiment of the invention;

FIG. 2 is a front view of one of the headlamp assemblies shown in FIG. 1;

FIG. 3 is a cross-sectional view of one of the headlamp assemblies shown in FIG. 2, as taken along the line 3-3;

FIG. 4 is an enlarged cross-sectional view of the headlamp assembly shown in FIG. 3, as encircled by circle 4; and

FIG. 5 is a cross-sectional view of a lamp assembly, according to another embodiment of the invention.

### DETAILED DESCRIPTION OF THE INVENTION

In the following figures, the same reference numerals are used to identify the same components in the various views.

Referring now to FIG. 1, there is shown a front-end structure 10 of a vehicle 12 with headlamp assemblies 14, according to one embodiment of the invention. It is contemplated that the lamp assembly 14 can instead be a tail lamp assembly or integrated in various other suitable vehicle body structures.

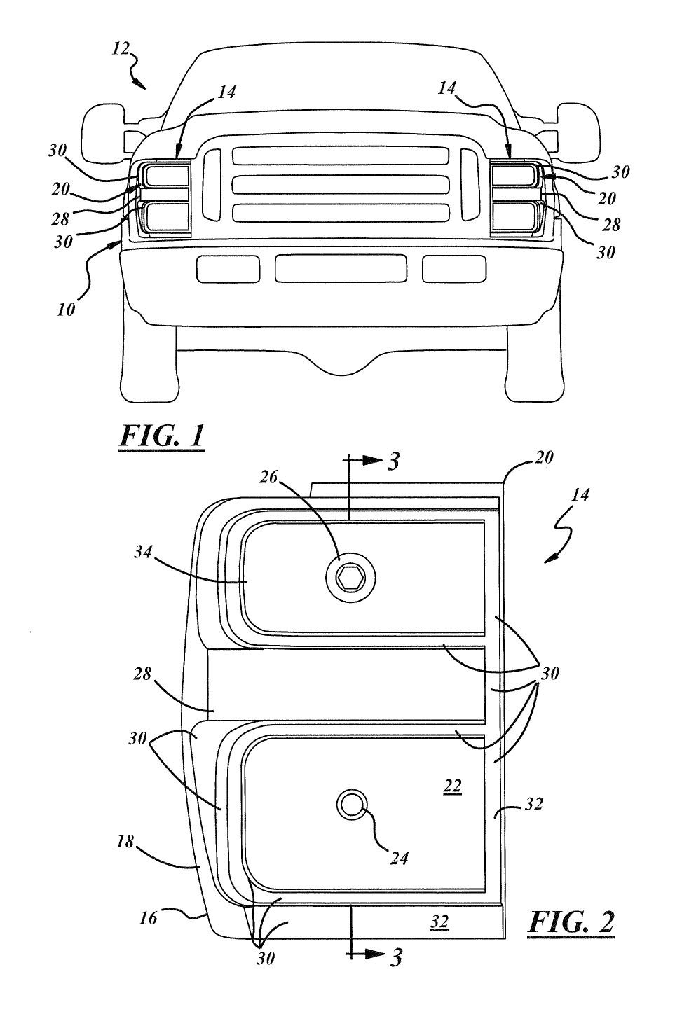

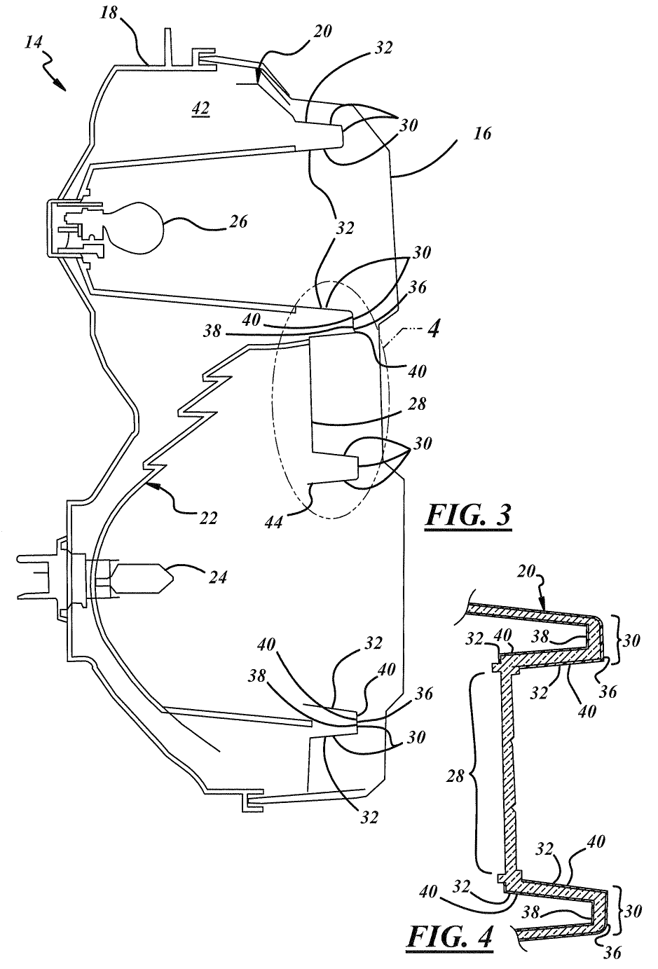

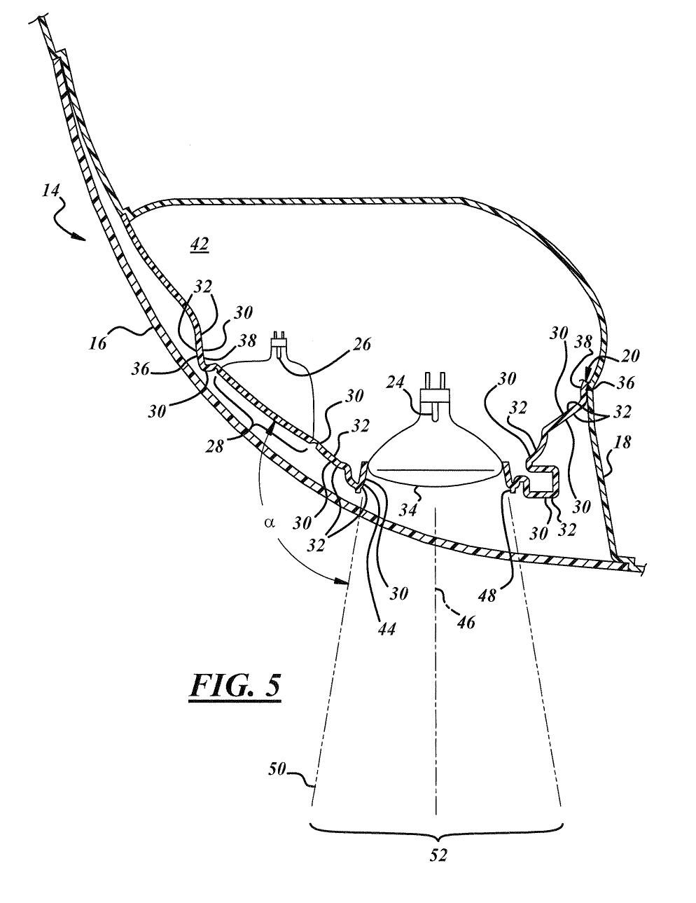

As shown in FIGS. 2 and 3, the headlamp assembly 14 includes an external lens 16, an external housing 18, a one-piece bezel-lens structure 20 (“bezel-lens”), a reflector 22, a first light source 24, and a second light source 26. As best shown in FIG. 4, bezel-lens 20 is formed from a light-transmissive material with an internal lens portion 28 and one or more opaque portions 30, created by coating with an opaque material 32. This feature is beneficial for eliminating the need for a separate inner lens, decreasing manufacturing cycle time, and minimizing costs associated therewith. However, as exemplified in the embodiment shown in FIG. 5, the lamp assembly 14 can also include a separate inner lens 34 attached to the bezel-lens 20 adjacent to internal lens portion 28 as desired.

Referring back to FIG. 4, opaque portions 30 of bezel-lens 20 have a fore side 36 and an aft side 38, which are coated with a metallic opaque material 40 that blocks the transmission of light through bezel-lens 20. However, it will be appreciated that only one of the sides 36, 38 can be coated with the metallic opaque material 40 or other suitable non-metallic opaque materials as desired.

Internal lens portion 28 of bezel-lens 20 is not coated with the metallic opaque material 40 and thus transmits the light emitted from first light source 24. In this embodiment, bezel-lens 20 is formed from transparent polycarbonate. However, it is contemplated that the bezel-lens 20 can instead be formed from translucent polycarbonate or various other materials as styling and/or engineering dictates. In manufacturing bezel-lens 20, the internal lens portion 28 is masked or otherwise covered with a suitable template prior to applying the metallic opaque material 40 to the opaque portions 30 of bezel-lens 20.

As best shown in FIG. 2, external housing 18 is attached to external lens 16 so as to define a sealed cavity 42, which encloses bezel-lens 20, reflector 22, first light source 24, and second light source 26. However, it is understood that bezel-lens 20 can be attached directly to external lens 16 and define the cavity 42 therebetween as desired. In this embodiment, bezel-lens 20 has an aperture 44 directly adjacent to the internal lens portion 28. Reflector 22 and first light source 24 extend from aperture 44, with the reflector 22 being configured for directing light from first light source 24 through both internal lens portion 28 and aperture 44. However, as detailed in the description for FIG. 5, separate light sources can be utilized for exclusively emitting light through the internal lens portion 28 and aperture 44.

First light source 24 is a high-intensity discharge (HID) lamp, and second light source 26 is an incandescent light bulb. It is contemplated that first light source 24 and second light source 26 can be any suitable combination of HID lamps, incandescent light bulbs, light emitting diodes, or various other light sources.

With attention now to FIG. 5, there is shown a cross-sectional view of a vehicle lamp assembly 14, according to an alternative embodiment of the invention. In this embodiment, reflector 22 is configured for directing light exclusively from the first light source 24 through aperture 44 and external lens 16. Second light source 26 is positioned for emitting light exclusively through internal lens portion 28 of bezel-lens 20 and external lens 16. In particular, aperture 44 has a longitudinal axis 46 extending orthogonally to the front rim 48 of the aperture 44. First light source 24 emits a beam 50 of light in a forward direction from the aperture 44 and along a path 52 generally defined by the longitudinal axis 46. The internal lens portion 28 is offset from the beam 50 of light by a predetermined angle α, e.g. at least 90 degrees, beyond the path 52 of light. Also, in this embodiment, internal lens portion 28 extends rearward from the aperture 44. However, internal lens portion 28 can instead be positioned for transmitting light from both the second light source 26 and the first light source 24 as desired. For instance, internal lens portion 28 can be positioned parallel to the front rim 48 of the aperture 44 or offset from the front rim 48 by less than 90 degrees as styling dictates.

In the embodiment illustrated in FIG. 5, lamp assembly 14 further includes an inner lens 34 attached to bezel-lens 20 within aperture 44.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. A lamp assembly for a vehicle, comprising:
an external lens;
a one-piece bezel-lens structure adjacent to said external lens;
said one-piece bezel-lens structure having at least one internal lens portion and at least one opaque portion;
said one-piece bezel-lens structure formed from a light-transmissive material;
said at least one opaque portion of said one-piece bezel-lens structure coated with an opaque material; and
at least one light source emitting light through said at least one internal lens portion of said one-piece bezel-lens structure.

2. The lamp assembly recited in claim 1 wherein said light-transmissive material is one of a translucent material and a transparent material.

3. The lamp assembly recited in claim 1 wherein said light-transmissive material is formed from a polycarbonate.

4. The lamp assembly recited in claim 1 wherein said at least one opaque portion of said one-piece bezel-lens structure has a fore side and an aft side, with at least one of said fore side and said aft side coated with said opaque material.

5. The lamp assembly recited in claim 1 wherein said opaque material is one of a metallic coating and non-metallic coating on said one-piece bezel-lens structure.

6. The lamp assembly recited in claim 1 wherein said one-piece bezel-lens structure is attached to said external lens by an external housing.

7. The lamp assembly recited in claim 1 wherein said at least one light source emits light indirectly through said at least one internal lens portion of said one-piece bezel-lens structure by a reflector.

8. The lamp assembly recited in claim 1 wherein said at least one light source emits light directly through said at least one internal lens portion of said one-piece bezel-lens structure.

9. The lamp assembly recited in claim 1 wherein said at least one light source is selected from the group consisting of an incandescent bulb, a light-emitting diode (LED) emitter, and a high intensity discharge bulb.

10. A vehicle comprising:
a vehicle body structure with said lamp assembly recited in claim 1.

11. A lamp assembly for a vehicle, comprising:
an external lens;
a one-piece bezel-lens structure adjacent to said external lens;
said one-piece bezel-lens structure having at least one internal lens portion, at least one opaque portion, and an aperture;
said one-piece bezel-lens structure formed from a light-transmissive material;
said at least one opaque portion of said one-piece bezel-lens structure coated with an opaque material;
an inner lens within said aperture of said one-piece bezel-lens structure; and
at least one light source emitting light through said inner lens and said at least one internal lens portion of said one-piece bezel-lens structure.

12. The lamp assembly recited in claim 11 wherein said bezel has a fore side and an aft side with said external lens adjacent to said fore side.

13. The lamp assembly recited in claim 11 wherein said light-transmissive material is one of a translucent material and a transparent material.

14. The lamp assembly recited in claim 11 wherein said at least one opaque portion of said one-piece bezel-lens structure has a fore side and an aft side, with at least one of said fore side and said aft side coated with said opaque material.

15. The lamp assembly recited in claim 11 wherein said opaque material is one of a metallic coating and a non-metallic coating on said one-piece bezel-lens structure.

16. The lamp assembly recited in claim 11 wherein said at least one light source emits a portion of light indirectly through said inner lens and said at least one internal lens portion of said one-piece bezel-lens structure by a reflector.

17. A vehicle comprising:
a vehicle body structure with said lamp assembly recited in claim 11.

18. A lamp assembly for a vehicle, comprising:
an external lens;
a one-piece bezel-lens structure adjacent to said external lens;
said one-piece bezel-lens structure having an internal lens portion, at least one opaque portion, and an aperture;
said one-piece bezel-lens structure formed from a light-transmissive material;
said at least one opaque portion of said one-piece bezel-lens structure coated with an opaque material;
an inner lens within said aperture of said one-piece bezel-lens structure;
a first light source emitting light through said inner lens and said external lens; and
a second light source emitting light through said internal lens portion of said one-piece bezel-lens structure and said external lens.

19. The lamp assembly recited in claim 16 wherein said bezel has a longitudinal axis extending orthogonally to a front rim of said aperture.

20. The lamp assembly recited in claim 19 wherein said internal lens portion extends from said aperture rearward along said longitudinal axis.
